(19) United States
(12) Patent Application Publication
(10) Pub. No.: US 2007/0223909 A1
(43) Pub. Date: Sep. 27, 2007

(54) Camera phone, method of controlling the camera phone, and photography support method used for the camera phone

(75) Inventor: Hideya Tanaka, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/727,250

(22) Filed: Mar. 26, 2007

(30) Foreign Application Priority Data
Mar. 27, 2006 (JP) 2006-085011

(51) Int. Cl. G03B 17/18

(52) U.S. Cl. 396/287

(57) ABSTRACT

A camera phone according to an embodiment of the invention assists a user in photography upon generating a composite image based on captured images through mosaicing processing or super-resolution processing with the optimum amount of photography images. To that end, a photographing condition analyzing unit analyzing a current photographing condition is provided, and a condition analysis result from the photographing condition analyzing unit is displayed for a user.

### BACKGROUND OF THE INVENTION

1. Field of the Invention

The present invention relates to a camera phone for capturing images to generate a composite image, a method of controlling the camera phone, and a photography support method used for the camera phone.

2. Description of Related Art

Mosaicing processing was originally used as a technique of combining analog still images such as air photography after photographing. Digital cameras were developed afterwards, and mosaicing processing based on digital processing was realized. Further, in addition to the field of air photography, the mosaicing processing had been modified as a technique of precisely controlling a camera position to seamlessly combine still images. After that, the mosaicing technique for still images has developed to mosaicing processing for moving pictures. However, even at the time of combining the moving pictures, a camera position should be still controlled.

To that end, a mosaicing technique directed at a camera phone the position of which cannot be precisely controlled because of its handheld shape, has been recently under study. This technique performs mosaicing processing as post processing after capturing moving pictures based on moving-picture compression such as an MPEG (Moving Picture Experts Group), or mosaicing processing together with super-resolution processing (for example, see Japanese Unexamined Patent Application Publication Nos. 11-234501 and 2005-20761).

Nowadays, in the case of saving or transferring texts written on paper or photographs in the form of digitalized image data, image data is generally obtained with a flat head scanner or the like. However, such scanner is large and not easily portable. Thus, if the image data could be obtained with a camera-equipped device such as a camera phone, a user can easily obtain high-definition images. However, a resolution of an image captured with a general camera-equipped device is much lower than that of the flat head scanner on the assumption that a substantially A4-sized sheet is photographed at a time.

To that end, IEICE Transactions on Information and Systems, PT. 2, Vol. J88-D-II, NO. 8, pp. 1490-1498, August 2005 reports a technique of executing mosaicing and super-resolution processings on moving pictures captured with a camera-equipped device to obtain a high-definition image. The above technique is directed to print including texts and images.

A general camera phone for such mosaicing and super-resolution processings is now described. FIG. 12 is a block diagram of the general camera phone. A portable device 500 includes a photographic camera 510, an image compressing unit 520 for compressing an image taken with the camera 510, and an auxiliary storage 550 for storing the compressed image. The device 500 further includes an image decompressing unit 530 for decompressing and decoding the compressed image and a display 580 for displaying the decoded image. Further, the device 500 includes a keyboard 590 via which a user enters instructions, a speaker 540 that outputs sounds, a memory 570, and a CPU 560. The above units are connected with each other via bus lines. Such a camera phone carries out mosaicing processing and super-resolution processing based on moving pictures captured with the camera 510 under the control of the CPU 560.

FIG. 13 is a flowchart of a mosaicing and super-resolution processing method. As shown in FIG. 13, moving pictures are first taken (step S101). After the completion of photographing (step S102: Yes), mosaicing processing and super-resolution processing are carried out (step S103, 104). Upon the completion of processing all of target images (step S105), the processing is ended.

However, the mosaicing processing or super-resolution processing with the camera-equipped portable device has the following problem. That is, as for the mosaicing processing, if a target image is, for example, a rectangular image such as print, the entire image should be captured. In general, a user relies on memory or follows one's hunches to confirm a photographed area. Thus, if an inexperienced user uses the device, areas remain unphotographed, with the result that mosaicing processing for a target area cannot be finished, and a desired mosaic image cannot be obtained.

### SUMMARY OF THE INVENTION

A camera phone according to an aspect of the present invention includes: a camera capturing images to generate a composite image; a photographing condition analyzing unit analyzing a current photographing condition of the camera; and a photographing condition notifying unit notifying a user of an analysis result from the photographing condition analyzing unit.

According to the present invention, it is possible to provide a camera phone that aids a user in camera operations to attain a proper photography amount at the time of generating various composite images based on images captured by a user, a method of controlling the camera phone, and a photography support method.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of a camera phone according to an embodiment of the present invention;

FIG. 2 shows a photographing condition analyzing unit and its peripheral blocks of the camera phone according to the embodiment of the present invention;

FIG. 3 illustrates motion information used in the camera phone according to the embodiment of the present invention;

FIG. 4 shows a camera movement track of the camera phone according to the embodiment of the present invention;

FIG. 5 shows a photographed area map created with a photographed-area creating unit of the camera phone according to the embodiment of the present invention based on a camera movement track;

FIG. 6 shows another photographed area map created with the photographed-area creating unit of the camera phone according to the embodiment of the present invention based on the camera movement track;

FIG. 7 shows another photographed area map created with the photographed-area creating unit of the camera phone according to the embodiment of the present invention based on the camera movement track;

FIG. 8 shows animation of a photographed area map created with the photographed-area creating unit of the camera phone according to the embodiment of the present invention based on the camera movement track;

FIGS. 9A and 9B show display image examples of a mask image generated with a mask image generating unit of the camera phone according to the embodiment of the present invention during photography;

FIG. 10 shows a display image example of a photographed area map created with the photographed-area creating unit of the camera phone according to the embodiment of the present invention based on the camera movement track after photography;

FIG. 11 is a flowchart of operations of the camera phone according to the embodiment of the present invention;

FIG. 12 is a block diagram of a general camera phone; and

FIG. 13 is a flowchart of operations of the general camera phone.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Embodiments of the present invention are described below in detail with reference to the accompanying drawings. Precise positional control on a transportable mobile device such as a camera phone, a digital camera, or a digital video camera is difficult, for instance. The following embodiment enables formation of a composite image by notifying a user of a photographed area even in such portable device the position of which cannot be precisely controlled, to thereby aid in photography upon forming the composite image.

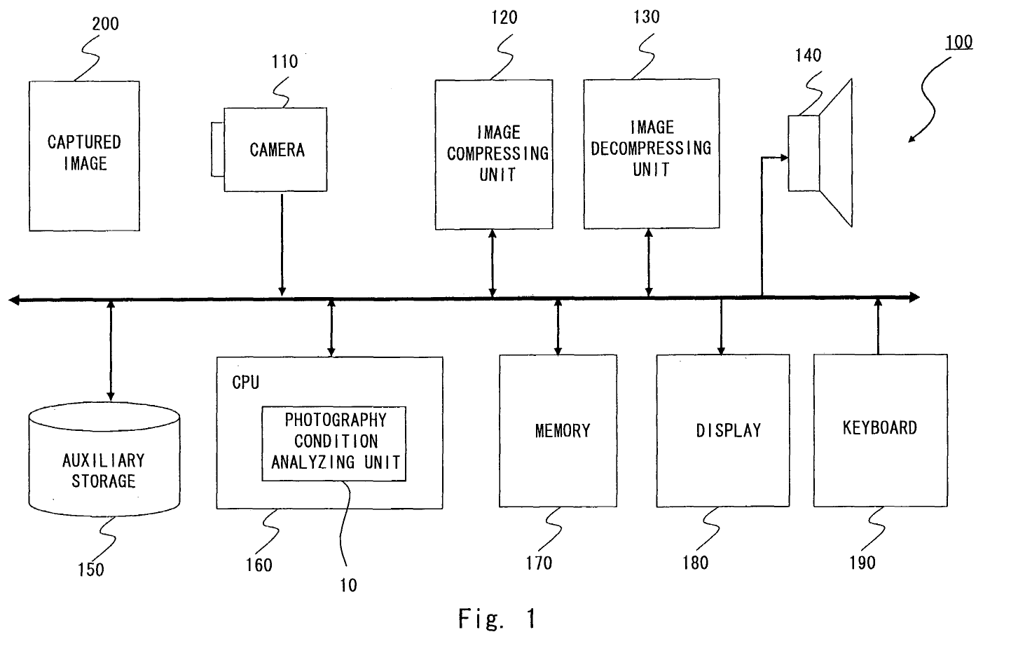

FIG. 1 is a block diagram of a camera phone according to an embodiment of the present invention. As shown in FIG. 1, a camera phone 100 includes a camera 110 for taking an image, an image compressing unit 120 for encoding and compressing the image taken with the camera 110, and an image decompressing unit 130 for decompressing and decoding the compressed image. Further, the camera phone 100 includes a speaker 140 for outputting sounds, an auxiliary storage 150 storing a taken image, a CPU 160, a memory 170 storing programs or the like, a display 180 displaying a taken image, and a keyboard 190 via which a enters instructions and the like.

The above camera phone 100 compresses an image 200 taken with the camera 110 by the image compressing unit 120 and stores the compressed image in the auxiliary storage 150. In addition, the taken image stored in the auxiliary storage 150 is decompressed and decoded with the image decompressing unit 130 and then displayed on the display 180. The image compressing unit 120 and the image decompressing unit 130 are software which are driven by the CPU 160 reading and executing programs stored in the memory 170 or the auxiliary storage 150.

In addition, if sounds as well as images are recorded, the images are displayed on the display 180 and at the same time, the sounds are output from the speaker 140. In addition, the speaker 140 can additionally output button sounds or alert sounds. In addition, the display 180 and the speaker 140 of this embodiment function as a photographing condition notifying unit for notifying a user of a current photographing condition during or after photography as described below.

The keyboard 190 is an input unit via which a user enters instructions. For example, a command to start photography, a command to end photography, a delete command, a save command, an edit command, or the like can be input. In response to the user's instructions, the CPU 160 controls each block, reads necessary programs from the memory 170, and executes various operations based on programs.

Here, the camera phone 100 of this embodiment includes a photographing condition analyzing unit 10 for analyzing current photographing conditions for aiding a user in photography. The photographing condition analyzing unit 10 is a software that is driven by the CPU 160 reading and executing programs stored in the memory 170 or the auxiliary storage 150.

The photographing condition analyzing unit 10 is a processing unit for aiding a user in obtaining images necessary for generating a composite image through, for example, mosaicing processing or super-resolution processing. As described in detail below, this unit helps a user obtain necessary images during or after photography or sends an error notification to aid the user in obtaining a composite image.

For example, even for a poster, print, or other such area larger than the angle of field of the camera, or an area whose image becomes indistinct if the entire area is photographed, mosaicing processing and super-resolution processing are combined to thereby obtain high-definition digital image data. A post processing unit (not shown) executing the mosaicing processing or the super-resolution processing is realized by the CPU 160 based on a captured image. The following description is made on the assumption that mosaicing and super-resolution processings are carried out on images of flat and rectangular areas for ease of explanation. In addition, the mosaicing and/or the super-resolution processing is referred to as “post processing”. Further, a rectangular area subjected to the post processing is referred to as a target area. Incidentally, an area to be photographed, that is, an area subjected to mosaicing and super-resolution processings may be, of course, a flat area such as a landscape image aside from the rectangular area.

Here, the mosaicing processing and super-resolution processing are described in brief. A mosaicing processing technique of combining plural partial images captured with a small camera to compose the images is combined with a super-resolution processing technique of generating a high-definition image based on a superimposed image of moving pictures, making it possible to read an A4-sized text with a camera of a camera phone or the like, for example, in place of a scanner. The mosaicing processing generates a wide-field image (mosaic image) of a subject that is flat or seemingly almost flat like a long-distance view, which exceeds the original angle of view of the camera. If the entire subject image cannot be taken by the camera, the subject is partially photographed plural times in different camera positions and orientations. The captured images are combined to generate the whole subject image.

In addition, the super-resolution processing combines plural images obtained by photographing a subject with the angle changed a little to assume/reconstruct data on details of a subject to generate a high-definition image beyond the intrinsic performance of the camera. In a super-resolution technique as disclosed in Japanese Unexamined Patent Application Publication No. 11-234501, a part of a subject is photographed while the camera position is changed and movements in moving pictures are analyzed to estimate camera movements such as a three-dimensional position of the camera or image-taking direction upon capturing each frame image on real time. Based on the estimated result, the mosaicing processing is carried out. Thus, a mosaic image can be taken while a camera is held in hand and freely moved without using a special camera scanning mechanism or positional sensor. Further, high image quality equivalent to a quality of an image read with a scanner is realized through super-resolution processing based on high-definition camera movement estimation.

Incidentally, to obtain correct results of the post processing, it is necessary to photograph the whole area of the target area and to appropriately superimpose images. However, in the case where images necessary for post processing are captured with a camera phone, a user has no choice but to follows one's hunches upon taking the images, so it cannot be checked whether or not sufficient images can be taken. To that end, a photographing device of this embodiment is equipped with the photographing condition analyzing unit 10 to notify a user of at least one of a photographed area shape, a superimposed area of photographed areas, and a track of a camera that is photographing or has photographed a target area during or after photography. Hence, a user is assisted to obtain normal results of the post processing, that is, to obtain images necessary for the post processing. In addition, if it is difficult to obtain normal results, a user receives information to select whether or not to perform photographing again or encourage the user to perform photographing again.

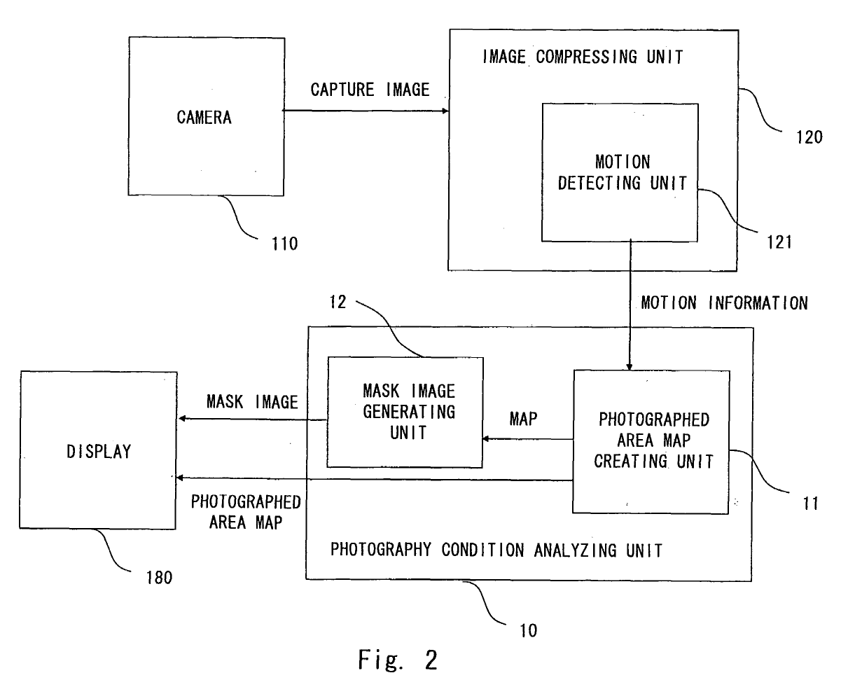

Next, the photographing result analysis executed by the photographing condition analyzing unit 10 is described in more detail. The following description is made of an example where the camera 110 captures moving pictures to subject the moving pictures to the post processing to obtain a composite image. Incidentally, this embodiment describes moving pictures by way of example, but a composite image may be generated based on plural still images. FIG. 2 shows the photographing condition analyzing unit 10 and its peripheral blocks. The photographing condition analyzing unit 10 of this embodiment includes a photographed-area creating unit 11 for creating a photographed area map based on motion information from a motion detecting unit 121 of the image compressing unit 120, and a mask image generating unit 12 for generating a composite image based on the created photographed area map.

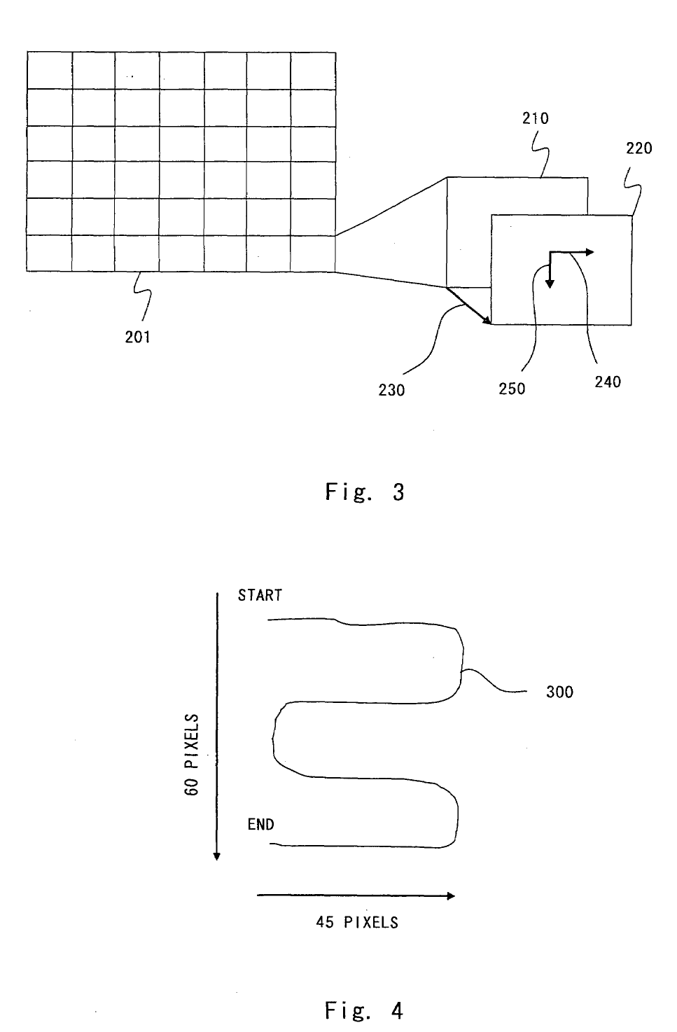

Here, the image compressing unit 120 executes, for example, well-known image compression such as MPEG to compress a captured image. In this case, the image compressing unit 120 divides the entire photography area of the camera 110 into several macro blocks to execute processing for each block. FIG. 3 illustrates moving picture processing. In a photography area 201, a macro block 210 at a given point of time is compared with a macro block 220 after the elapse of Δ period 230 to calculate a displacement 240 in the X-axis direction and a displacement 250 in the Y-axis direction. In this example, the displacement 240 in the X-axis direction and the displacement 250 in the Y-axis direction may be calculated based on one macro block or obtained by averaging displacements of all macro blocks or by extracting specific macro blocks at the corner or center to average the displacements of these blocks. The motion detecting unit 121 of the image compressing unit 120 calculates the displacements 240 and 250, and the image compressing unit 120 compresses moving pictures based on the displacements 240 and 250.

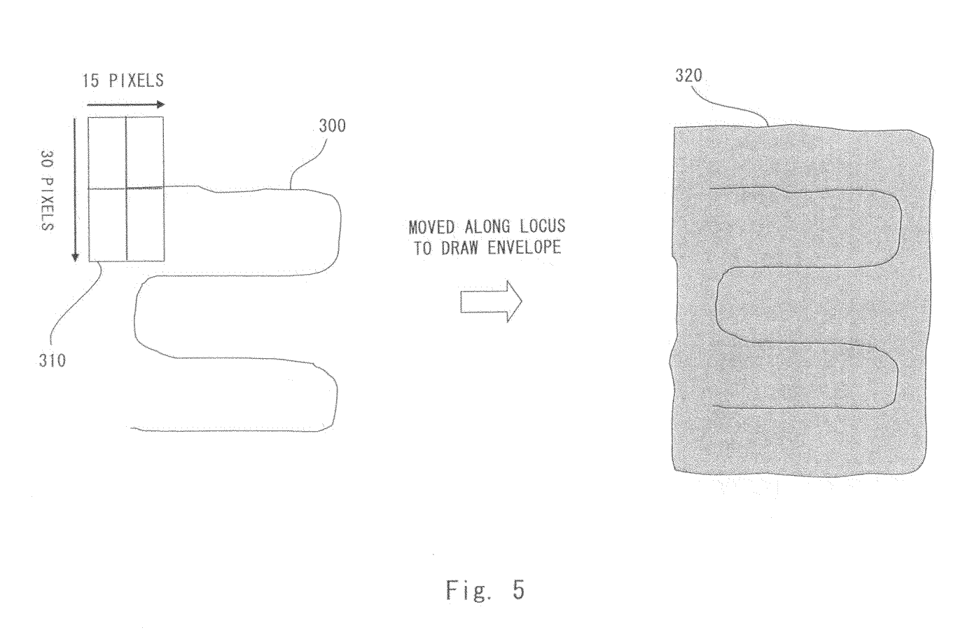

The photographed-area creating unit 11 of this embodiment calculates the displacements 240 and 250 as motion information to thereby obtain information about the first area to a currently photographed area during photography, and obtain information about the total photographed areas of the first area to the last area after photography. In general, the camera phone includes the image compressing unit 120 or its equivalent to obtain motion information. In this way, motion information is obtained from the equipped image compressing unit 120 to calculate a displacement, making it unnecessary to add a motion information detecting unit or the like. FIGS. 4 and 5 show information about photography areas. The photographed-area creating unit 11 of this embodiment evaluates a movement track 300 of a fixed point such as a center point of the camera photography area as the information about photography areas, based on the displacements 240 and 250.

That is, based on the information from the motion detecting unit 121, movement information such as information of how far a current photography area is from a previous photography area in terms of pixels in vertical and horizontal directions (displacement) can be obtained. The movement information are saved from the start to the end of photography, and combined to thereby determine the movement track of the fixed point. For example, in the case of forming a composite image of an area measuring 60 pixels (length)×45 pixels (width), the movement track of the center point as shown in FIG. 4 is obtained. Further, if the photography area (view angle) 201 of the camera 110 measures, for example, 30 pixels (length)×15 pixels (width), as shown in FIG. 5, the photography area 201 is moved along the movement track 300 to thereby derive the total photographed area 320.

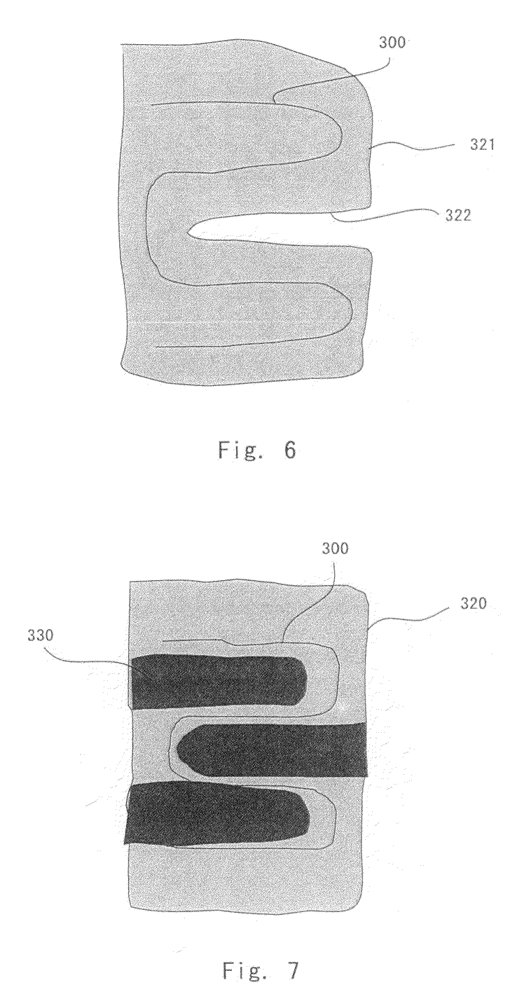

If the target area measures 60 pixels (length)×45 pixels (width) as described above, the total photographed area is displayed for a user to thereby determined whether or not a target area is completely photographed. That is, as shown in FIG. 6, for example, in the entire photographed area 321, a non-superimposed area 322 where taken images are not superimposed is formed in some cases while being not noticed by a user. In this case, in a subsequent post processing, the composite image cannot be completed. The photographed-area creating unit 11 creates a map for displaying such photographed areas (photographed area map) based on the motion information from the motion detecting unit 121.

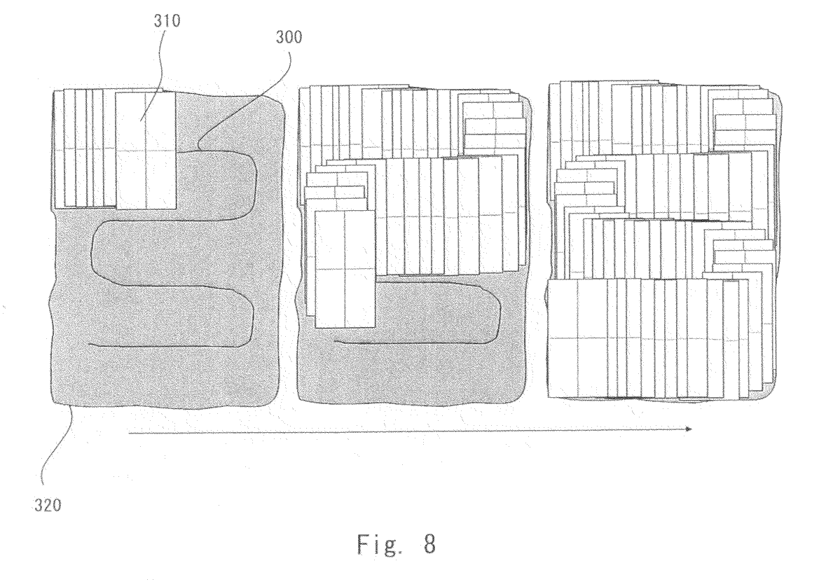

As conceivable examples of the photographed area map, there are a map representing the movement track as shown in FIG. 4, a map representing the entire photographed area 320 as shown in FIG. 5 or as shown in FIG. 7, or a map representing the degree in which taken images are superimposed in luminance or color 330. Alternatively, as shown in FIG. 8, the photography area 310 and movement track 300 of the camera may be animated and displayed together with the entire photographed area 320.

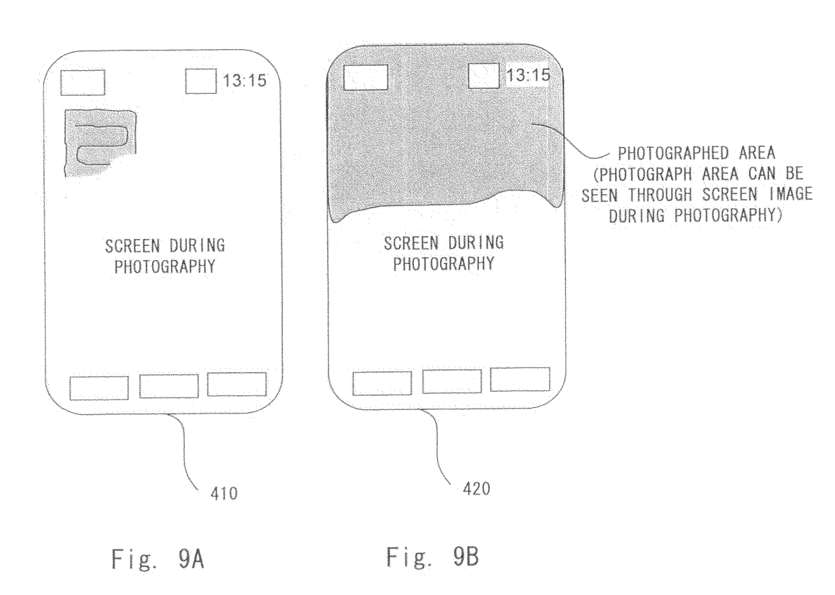

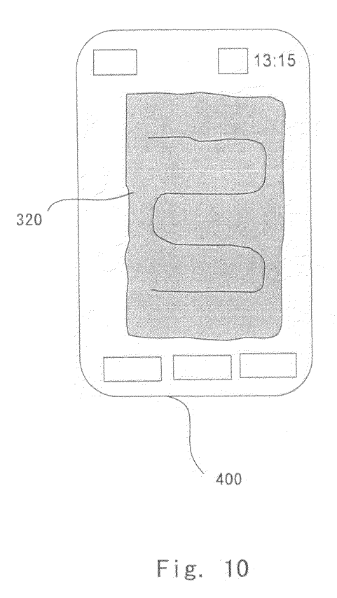

Here, these photographed area maps may be displayed on the display 180 after photography. In this embodiment, however, even during photography, the photographed area is displayed, so a user can determine whether or not correct operations are executed during photography. Therefore, the photographing condition analyzing unit 10 includes the mask image generating unit 12. The mask image generating unit 12 receives the photographed area map during photography to generate a display image (mask image) for helping a user check the entire photographed area 320 at this point. As the mask image, as shown in FIG. 9A, the entire photographed area is reduced and displayed on a part of the screen during photography (at the left corner in this embodiment). Alternatively, as shown in FIG. 9B, the entire photographed area is displayed on the screen during photography in the see-through form. The mask image generating unit 12 generates a reduced display image that is reduced and displayed in this way to compose the image with a screen image during photography or to compose an image of the photographed area to the screen image during photography such that the image can be seen therethrough. Then, the image is displayed as a mask image on the display 180. Incidentally, this embodiment describes the example where the mask image generating unit 12 is provided to generate a mask image that helps a user grasp the entire photographed area 320 at this point. However, if the photographed area is not displayed during photography, the mask image generating unit 12 may be omitted.

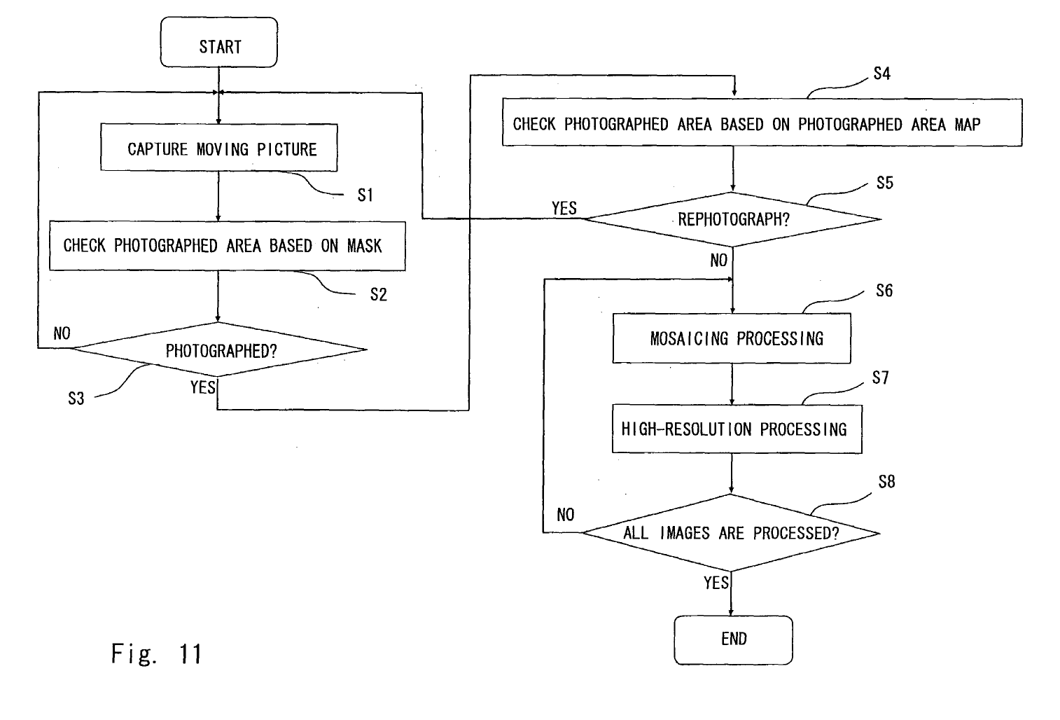

On the other hand, as shown in FIG. 10, if the entire photographed area is notified after photography, the entire photographed areas (photographed area map) 320 created with the photographed-area creating unit 11 as shown in FIGS. 5 to 8 may be displayed on a screen.

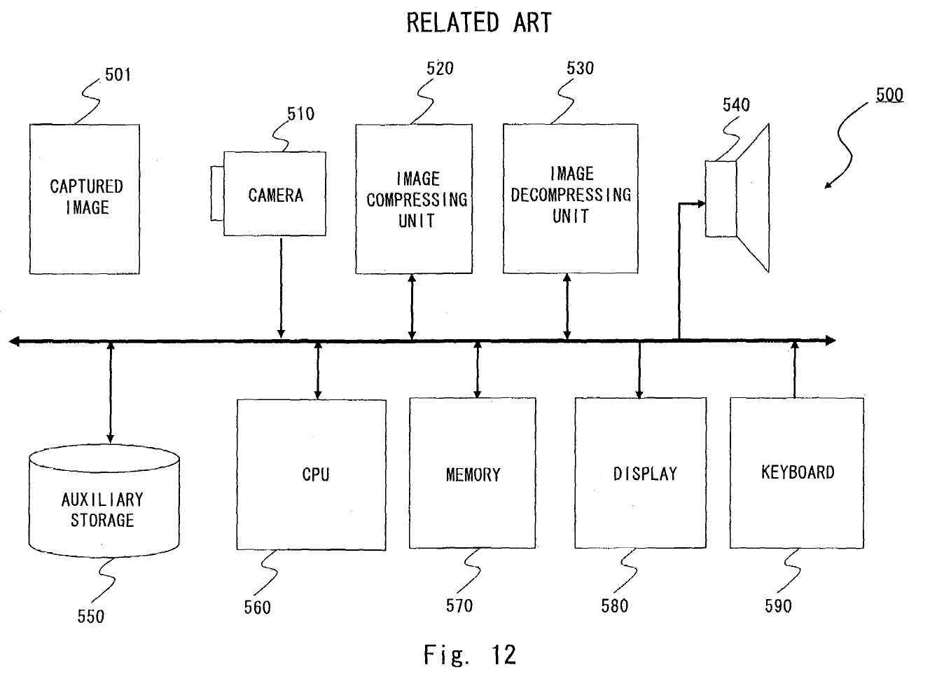

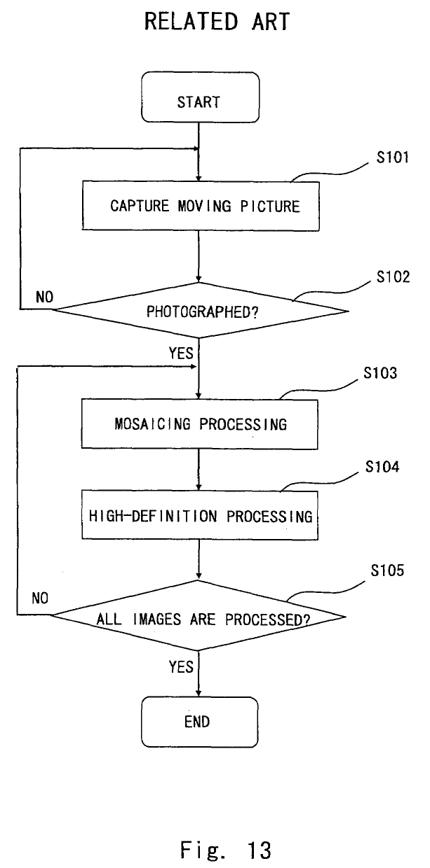

Next, operations of the camera phone of this embodiment are described. FIG. 11 is a flowchart of the operations of the camera phone of this embodiment. As shown in FIG. 11, an area subjected to the post processing is first photographed to obtain moving pictures (step S1). Upon photographing the moving pictures, the photographed-area creating unit 11 obtains motion information based on processing results of the motion detecting unit 121 of the image compressing unit 120 at a predetermined timing or a timing designated by an external unit to create a photographed area map. The mask image generating unit 12 masks a capture image to be displayed on the display 180 to generate a mask image based on the photographed area map (see FIG. 9). The mask image is displayed on the display 180, so a user can grasp how far target areas are photographed (step S2). After the completion of photographing the target areas (step S3: Yes), an image of the entire photographed area (photographed area map) for final confirmation is displayed to notify a user of the photography area (see step S4, FIG. 10).

The user checks the photographed area map, and if a unphotographed area 322 remains as in the photographed area 321 of FIG. 6, for example, the user determines that the area should be photographed again (step S5: Yes) to return the process to step S1 where the moving pictures are captured again. At this time, only the unphotographed area 322 may be captured or the whole areas may be photographed again. On the other hand, as shown in FIG. 5, if it is determined that the total photographed area 320 covering the target areas is obtained, a command to execute the post processing is sent. Then, all of the captured images undergo mosaicing processing and super-resolution processing one by one to generate a composite image (steps S6 to S8).

According to this embodiment, the camera phone displays the photographed area at a timing prior to the post processing such as the mosaicing processing or mosaicing and super-resolution processings and during and after photographing of target areas subjected to the post processing. As described above, the entire photographed area obtained during or after capturing of moving pictures of the target areas is displayed. Thus, a user does not need to rely on memory or follow one's hunches. That is, at the time of generating a composite image, for example, if a rectangular area is a target area, a user recognizes the shape. Hence, if the area 321 as shown in FIG. 6 is displayed as the entire photographed area, a user can recognize a failure at once. As a result, a user is encouraged to photograph the area again.

In addition, as a method of displaying the photographed area, the area superimposition degree as well as the shape of the entire photographed area and the camera movement track can be displayed for a user. Moreover, a superimposed area may be displayed with the higher color density. Alternatively, the camera movement track or the photography area shape alone is displayed at the initial stage, for example, and the process of photographing target areas is animated and displayed for a user.

Based on these information, if determining that photography information is insufficient, a user can select rephotographing to obtain necessary images throughout the target areas. In addition, based on the displayed photographed area, if determining that too much photography information is obtained, a photographing method may be improved to realize a proper photography amount such as increasing a moving speed of the camera. In particular, a photographed area is provided as auxiliary information for a user unaccustomed to an application of the mosaicing processing to facilitate the application.

In addition, an unphotographed area can be notified before the completion of photographing by displaying a mask image such as schematically displaying a photographed area throughout the screen or on a part of the screen not only at the completion of photographing but also during photographing. As a result, it is possible to avoid such a situation that an unphotographed area remains in target areas for generating a composite image, through the post processing. Likewise, it is possible to avoid such a situation that an excessive number of moving pictures are captured. Hence, a proper number of moving pictures for the post processing can be captured.

Further, a proper number of moving pictures for the post processing are captured, so long processing time is not necessary after the post processing. In addition, a composite image obtained through the post processing has an appropriate size, and a data capacity of the auxiliary storage 150 necessary for storing this image is not so large.

Moreover, if information is insufficient, the displayed photographed area encourages a user to rephotograph the area. The user can determine whether or not to rephotograph the area by checking the displayed photographed area in practice. Therefore, if a probability of obtaining a desired composite image even after post processing is low, the post processing may be omitted. An unnecessary processing can be omitted, and processing time and power consumption can be reduced.

In addition, the displayed photographed area is information for making a decision as to whether necessary moving pictures of a target area are taken, so high accuracy is not required. Further, the motion information used in the moving picture compressing unit may be used to evaluate the movement track. Hence, particularly complicated calculation is not necessary, power consumption is not increased, and an additional hardware component is unnecessary.

Incidentally, as described above, an image may be output from the photographed-area creating unit 11 or the mask image generating unit 12 during or after photography, or at a timing selected by a user. The mask image generating unit can be omitted in the case of only notifying the photographed area after photography. Alternatively, a mask image may be displayed after photography.

Incidentally, the above embodiment describes the example where the mosaicing processing and super-resolution processing are executed after photographing moving pictures. That is, after the completion of capturing moving pictures, the mosaicing processing and the super-resolution processing are executed. According to this method, a user needs to wait until the post processing is completed. Therefore, if a processor speed is high enough, while capturing moving pictures, a user can perform the mosaicing processing and the super-resolution processing. The moving pictures are captured in parallel with the post processing to allow the user to obtain the result of mosaicing processing and super-resolution processing more speedily than that of the post processing executed substantially at the timing when the moving pictures have been captured. Even in this case, similar to the above embodiment, auxiliary information for obtaining a proper composite image may be sent to a user by displaying a photographed area or notification about an abnormal moving speed during photography.

In addition, the above embodiment describes the example where a photographed area is displayed or a moving speed is detected based on the motion information of the image compressing unit 120, but a photographing device for capturing and storing moving pictures in a decompressed form may be used. In this case, the motion detecting unit is separately provided to detect the photographed area or moving speeds. Further, in this embodiment, the post processing includes the mosaicing processing and super-resolution processing, so the processing is carried out such that the photographed area or moving speed is notified to obtain photographed area with an appropriate superimposed amount throughout the target areas. However, another composite image processing may be executed. In this case, a user may be assisted in photography by controlling a photographed area or camera moving speed to obtain a photography area necessary for the composite image processing.

Further, the above embodiment describes the hardware components. However, the invention is not limited thereto, and processing of each block can be also performed by a CPU (Central Processing Unit) executing a computer program. In this case, the computer program can be recoded on a recording medium and provided or transferred through the Internet or such other transfer media.

It is apparent that the present invention is not limited to the above embodiment that may be modified and changed without departing from the scope and spirit of the invention.

What is claimed is:

1. A camera phone, comprising:
a camera capturing images to generate a composite image;
a photographing condition analyzing unit analyzing a current photographing condition of the camera; and
a photographing condition notifying unit notifying a user of an analysis result from the photographing condition analyzing unit.

2. The camera phone according to claim 1, wherein the photographing condition notifying unit notifies a user of the analysis result at least one of during or after capturing the images.

3. The camera phone according to claim 1, wherein the photographing condition analyzing unit analyzes at least one of a photographed area at present time, a superimposed amount of photography areas, and a camera movement track of the photographed area at present time.

4. The camera phone according to claim 2, wherein the photographing condition analyzing unit analyzes at least one of a photographed area at present time, a superimposed amount of photographed areas, and a camera movement track of the photographed area at present time.

5. The camera phone according to claim 1, wherein the photographing condition analyzing unit analyzes a movement track of the camera based on displacements in an X-axis direction and a Y-axis direction, which are derived from previous and subsequent images.

6. The camera phone according to claim 2, wherein the photographing condition analyzing unit analyzes a movement track of the camera based on displacements in an X-axis direction and a Y-axis direction, which are derived from previous and subsequent images.

7. The camera phone according to claim 1, further comprising:
an image compressing unit executing image compression based on motion information derived from previous and subsequent images,
the photographing condition analyzing unit analyzing a movement track of the camera based on motion information upon the image compression.

8. The camera phone according to claim 2, further comprising:
an image compressing unit executing image compression based on motion information derived from previous and subsequent images,
the photographing condition analyzing unit analyzing a movement track of the camera based on motion information upon the image compression.

9. The camera phone according to claim 5, wherein the photographing condition notifying unit is a display unit to display the movement track of the camera as the analysis result.

10. The camera phone according to claim 7, wherein the photographing condition notifying unit is a display unit to display the movement track of the camera as the analysis result.

11. The camera phone according to claim 5, wherein the photographing condition analyzing unit creates a photographed area map showing a superimposed amount of photographed areas based on the movement track of the camera, and
the photographing condition notifying unit is a display unit to display the photographed area map as the analysis result.

12. The camera phone according to claim 7, wherein the photographing condition analyzing unit creates a photographed area map showing a superimposed amount of photographed areas based on the movement track of the camera, and
the photographing condition notifying unit is a display unit to display the photographed area map as the analysis result.

13. The camera phone according to claim 1, wherein the photographing condition analyzing unit composes at least one of a shape of a photography area at present time, a superimposed amount of photographed areas, and a movement track of the camera in the photographed area at present time to a screen image during photography, and
the photographing condition notifying unit is a display unit to display the composite image generated with the photographing condition analyzing unit as the analysis result.

14. The camera phone according to claim 2, wherein the photographing condition analyzing unit composes at least one of a shape of a photography area at present time, a superimposed amount of photographed areas, and a movement track of the camera in the photographed area at present time to a screen image during photography, and
the photographing condition notifying unit is a display unit to display the composite image generated with the photographing condition analyzing unit as the analysis result.

15. The camera phone according to claim 1, wherein the composite image is obtained by combining an image of an area larger than an angle of field of the camera.

16. The camera phone according to claim 1, wherein the captured image is a moving picture.

17. The camera phone according to claim 1, further comprising a mosaicing processing unit generating a mosaic image based on the captured image.

18. The camera phone according to claim 17, further comprising a super-resolution processing unit generating a super-resolution image based on the captured image.

19. A method of controlling a camera phone, comprising:
analyzing a current photographing condition of images captured for generating a composite image;
notifying a user of an analysis result; and
generating the composite image based on captured images.

20. A photography support method used in a camera phone, comprising:
analyzing a current photographing condition of a photographic camera; and
notifying a user of an analysis result to generate a composite image.
